(19) United States
(12) Patent Application Publication
(10) Pub. No.: US 2007/0021222 A1
(43) Pub. Date: Jan. 25, 2007

(54) Cardan shaft

(76) Inventor: Matthias Voigt, Haldensleben (DE)

Correspondence Address: SCHWABE, WILLIAMSON & WYATT, P.C.;PACWEST CENTER, SUITE 1900, 1211 SW FIFTH AVENUE, PORTLAND, OR, 97204, US

(21) Appl. No.: 11/486,598

(22) Filed: Jul. 14, 2006

(30) Foreign Application Priority Data
Jul. 14, 2005 (DE) 10 2005 032 865.2

(51) Int. Cl. F16D 3/00

(52) U.S. Cl. 464/146

(57) ABSTRACT

A cardan shaft (1) having a first shaft (2) and a second shaft (3) is connected in a torque-proof manner via a constant velocity joint (9). The second shaft (3) having two separate shaft sections (4, 5) connected to one another by a connector, which mechanically fails at the impact of a predetermined axial force such that the two shaft sections (4, 5) can be coaxially shifted into one another in a displacement section (6). In order to optimize the cardan shaft for the use in a vehicle with a front traverse installation driving motor and transmission, the constant velocity joint (9) and the connector at the two shaft sections (4, 5) may be configured and adjusted to one another such that at the outset of an initial impact of a predetermined first axial force (F1), weaker than a second subsequent axial force (F2), the constant velocity joint (9) is initially telescoped along a first shift path (S1) up to a block and upon a subsequent impact of a predetermined second axial force (F2) the two shaft sections (4, 5) telescope over a second shift path (S2).

### CROSS REFERENCE TO RELATED APPLICATIONS

The present application claims International Priority under 35 U.S.C. §119 to co-pending German Patent Application No. 10 2005 032 865.2, filed Jul. 14, 2005, entitled “Kardanwelle” the entire contents and disclosure of which is hereby incorporated by reference in its entirety.

### TECHNICAL FIELD

The invention relates to a driveshaft or cardan shaft, having a first shaft and a second shaft, connected to one another torque-proof via a constant velocity joint, and in which the second shaft is provided with two separate shaft sections, connected to one another by a connection means, which mechanically fails under the impact of a predetermined axial force such that the two shaft sections can be coaxially shifted into one another in a displacement section.

### BACKGROUND

Power trains often include a driveshaft that serves to transfer the driving torque from the motor-transmission combination to the vehicle wheels and are preferably integrated in a motor vehicle below the passenger compartment. A constant velocity joint connects the two shafts of the driveshaft in accordance with standard drive technology to allow, in particular, the compensation of different drive axes of the two shafts as well as the axial motion thereof developing during operation.

Additionally, available driveshafts may divide in a constructive manner one of the two shafts into two partial shafts and/or shaft sections, which are configured and arranged in reference to one another such that they can be shifted into one another in a coaxial manner in an axial displacement section, i.e. the two partial shafts can telescope. This ability to shift in an axial direction allows the driveshaft to be shortened by the impact of an axial force in case of an accident, and thus to avoid an undesired bending, for example in the direction of the passenger compartment.

In vehicles with a front traverse installation of the driving motor and transmission, as compared to longitudinally installed drive aggregates, relatively large operation-related motions occur in the longitudinal direction of the vehicle. Additionally, in such vehicles, a rotation of the motor-transmission unit around its vertical and/or horizontal axis frequently occurs in a frontal crash, so that a driveshaft, drive-connected to the transmission, buckles at a crash-related bending angle with a power component in the longitudinal direction of the vehicle longitudinal direction as well as a power component perpendicular thereto.

Even a conventional driveshaft with the above-described axial displacement unit tends to bend in such a situation because it buckles with an axial force reduced by the effective angle of the vehicle impact, which is insufficient to activate the axial displacement unit to act in the telescoping manner. This way, the driveshaft or parts thereof can penetrate undesirably into the interior of the vehicle and cause damage.

### SUMMARY OF INVENTION

It is accordingly an object of various embodiments of the invention to provide a cardan shaft that overcomes the hereinafore-mentioned disadvantages of the heretofore-known driveshaft devices of this general type and that can be shifted into one another coaxially in a displacement section without bending undesirably at a crash-related bending angle to thereby avoid penetrating into the interior of the vehicle following vehicle impact in a frontal crash.

With the foregoing and other objects in view, there is provided, in accordance with at least one embodiment of the invention, a cardan shaft (1) having a first shaft (2) and a second shaft (3) connected to one another via a constant velocity joint (9) in a torque-proof manner. The second shaft (3) having two separate shaft sections (4, 5) connected to one another via a connection means, such as a connector that mechanically fails at the impact of a predetermined axial force such that the two shaft sections (4, 5) can be shifted into one another coaxially in a displacement section (6). The constant velocity joint (9) and the connection means at the two shaft sections (4, 5) are configured and adjusted to one another such that at the onset of the impact of a predetermined first axial force (F1), the constant velocity (“CV”) joint (9) is initially telescoped over a first shift path (S1) up to the block. Subsequently at the impact of a predetermined second axial force (F2), stronger than the first axial force (F1), the two shaft sections (4, 5) telescope over a second shift path (S2).

This design advantageously causes an axial shortening of the cardan shaft even when the axial force level for the axial displacement unit comprising the two shaft sections has not yet been reached. Along a first shift path this cardan shaft is shortened impact-related in its axial length due to the constant velocity joint being telescoped to such an extent that the interior part of the joint and the exterior part of the joint axially contact.

In accordance with another feature of one embodiment of the invention, the first axial force (F1), in reference to the cardan shaft when configured free from torque, ranges from about 0 N to about 1000 N, or preferably from about 0 N to about 500 N, or more preferably from about 0 N to about 250 N.

When the axially effective increase in power further increases towards the cardan shaft, finally an axial force level is reached, at which the connection means between the two shaft sections mechanically fail and allow the cardan shaft to telescope over a second shift path.

In accordance with a further feature of one embodiment of the invention, the second axial force (F2), in reference to the cardan shaft when configured free from torque, ranges from about 1000 N to about 20000 N, or preferably from about 5000 N to about 15000 N, or more preferably from about 10000 N to about 12500 N.

Due to the fact that the impact-related shift path is divided into two sections becoming effective when two different axial power levels have been exceeded, on the one hand, the cardan shaft can react to the impact of a lower axial force in a manner of being shortened axially. Additionally, the early shortening of the cardan shaft in reference to the accident progression results in a more beneficial angle for the second shift path between the connection site of the cardan shaft and the transmission, out of alignment due to the accident.

In accordance with an added feature of one embodiment of the invention, the second axial force (F2), from which the two shaft sections (4, 5) telescope, can be adjusted by the embodiment of the connection means. In one embodiment, the connection means are embodied as welding spots between the two shaft sections (4, 5) that can tear under the impact of the axial force (F2). In further embodiments, the connection means are embodied as friction surfaces at the two shaft sections (4, 5) facing one another. Alternatively, various embodiments include connection means with connectors configured using a combination of welding spots and friction surfaces.

In accordance with yet a further feature of one embodiment of the invention, the first shift path (S1) of the constant velocity joint (9), to which it is telescoped to the block, amounts to no more than 50 mm in each axial direction.

In accordance with yet an additional feature of one embodiment of the invention, the second shift path (S2) of the two shaft sections (4, 5) amounts to no more than 500 mm.

In accordance with again another feature of one embodiment of the invention, the constant velocity joint (9) and the connection means of the two shaft sections (4, 5) are configured such that the power shaft, at a bending angle ranging from 0° to 10°, particularly from 0° to 5°, continues to behave according to the two step telescopic shifting as previously described.

In accordance with a concomitant feature of one embodiment of the invention, the constant velocity joint (9) and the connection means of the two shaft sections (4, 5) are configured such that the constant velocity joint (9) remains intact after the impact of the axial force (F2) and a telescoping of the two shaft sections (4, 5).

Other features that are considered as characteristic for various embodiments of the invention are set forth in the appended claims. The construction and method of operation of various illustrated embodiments of the invention, however, together with additional objects and advantages thereof, will be best understood from the following description of specific embodiments when read in connection with the accompanying drawings.

Although various embodiments of the invention are illustrated and described herein as embodied in a cardan shaft, it is, nevertheless, not intended to be limited to the details shown because various modifications and structural changes may be made therein without departing from the spirit of various embodiments of the invention and within the scope and range of equivalents of the claims.

### BRIEF DECRIPTION OF THE DRAWINGS

The present invention will be described by way of exemplary embodiments, but not limitations, illustrated in the accompanying drawings in which like references denote similar elements, and in which:

FIG. 1 is a perspective view a cardan shaft according to various embodiments of the invention that can be telescoped;

FIG. 2 is a cross-sectional view of the cardan shaft according to FIG. 1 with a displacement section, the constant velocity joint, and the bearing block for the central bearing; and

FIG. 3 is an enlarged detailed view of the cardan shaft according to FIG. 2 in the area of the constant velocity joint and the central bearing.

### DETAILED DESCRIPTION

In the following detailed description, reference is made to the accompanying drawings which form a part hereof wherein like numerals designate like parts throughout, and in which are shown, by way of illustration, specific embodiments in which the invention may be practiced. It is to be understood that other embodiments may be utilized and structural or logical changes may be made without departing from the scope of the present invention. Therefore, the following detailed description is not to be taken in a limiting sense, and the scope of the present invention is defined by the appended claims and their equivalents.

Reference in the specification to “one embodiment” or “an embodiment” means that a particular feature, structure, or characteristic described in connection with the embodiment is included in at least one embodiment. The appearances of the phrase “in one embodiment” in various places in the specification do not necessarily all refer to the same embodiment, but it may. The phrase “A/B” means “A or B”. The phrase “A and/or B” means “(A), (B), or (A and B)”. The phrase “at least one of A, B, and C” means “(A), (B), (C), (A and B), (A and C), (B and C) or (A, B and C)”. The phrase “(A) B” means “(A B) or (B)”, that is “A” is optional.

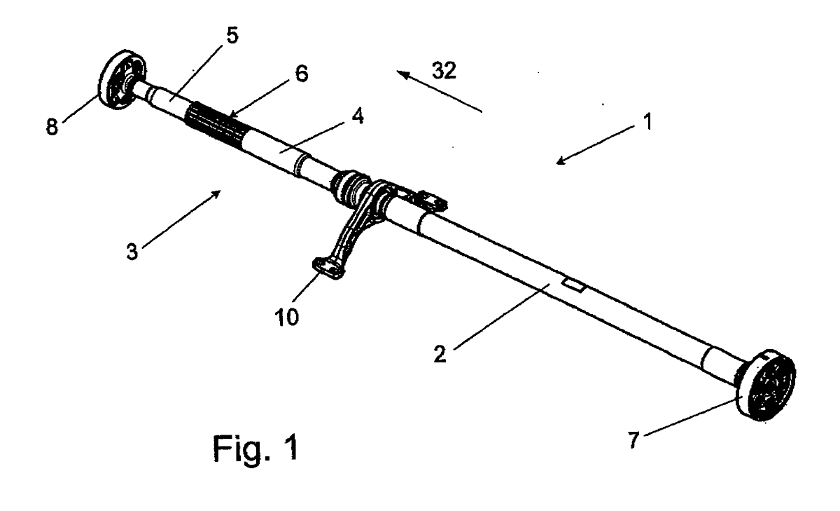

Referring to FIG. 1, a cardan shaft 1 according to one embodiment of the invention is shown comprising two partial shafts and being used, for example, in a motor vehicle with a front traverse installation drive motor and transmission. A first shaft 2 is connected to a second shaft 3 via a constant velocity joint 9 in a drive-effective manner. In the area of this constant velocity joint 9 a bearing block 10 is arranged to accept the central bearing 16, by which the cardan shaft 1 can be supported with its central section on the vehicle under body.

Both shafts 2 and 3 are connected at their free ends with flexible disks 7 and/or 8 in a manner known to those of skill in the art. The arrow 32 indicates the direction of the forward motion of the vehicle so that the flexible disk 8 can be connected to the output shaft of the vehicle transmission and the flexible disk 7 to the input of a differential gear.

The second shaft 3 is embodied in two parts and comprises a first shaft section 4 and a second shaft section 5, which can be coaxially displaced in reference to one another in the area of a displacement section 6 when a sufficiently strong axial force F2 acts upon it. In order to be able to implement the desired axial displacement the shaft sections 4 and 5 of the second shaft 3 facing one another are provided, for example, with an axial interlocking, which additionally allows the transmission of a torque, supports a purposeful sliding motion, and is configured such that this kinetic energy can be converted into a radial deformation work and/or into thermal energy.

For this purpose, it is advantageously provided for the second axial power level F2, which starts the telescoping motion of the two cardan shaft sections, to be adjustable by the embodiment of the connection means. Here, the connection means may be embodied as welding spots between the two shaft sections, which can break under the axial force F2, and/or as surfaces at the two shaft sections acting towards one another in friction-like manner.

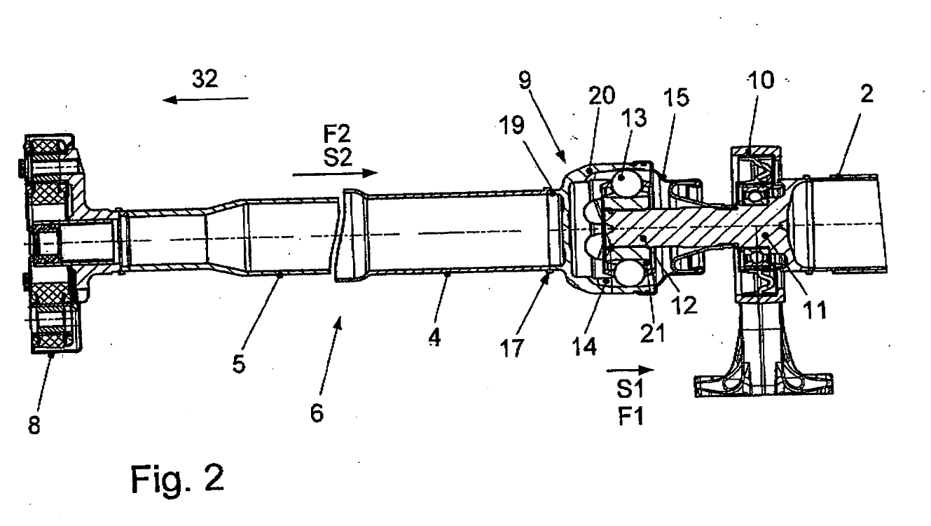

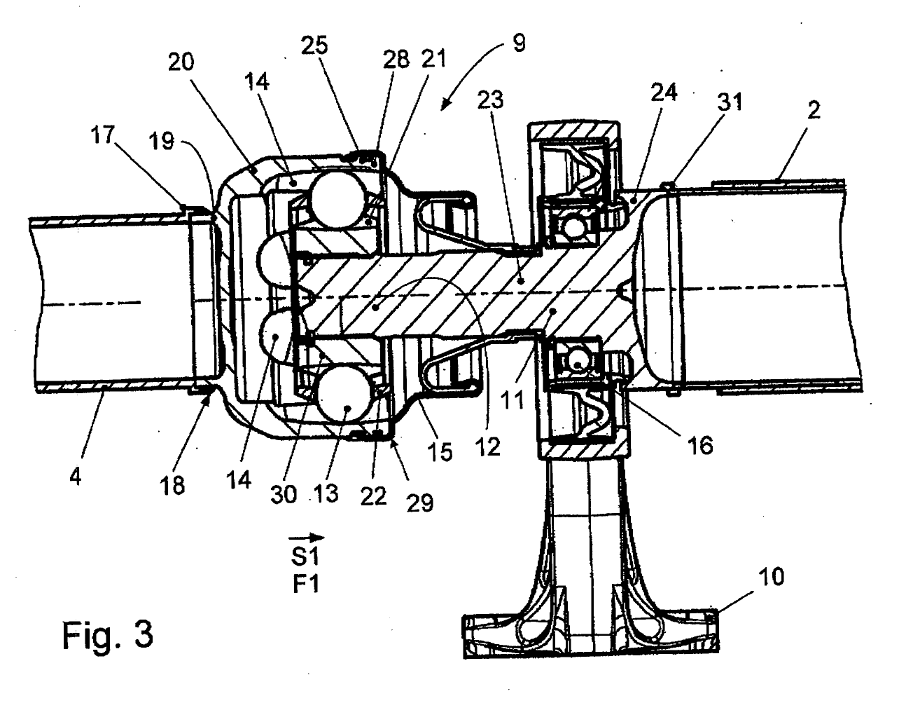

According to FIGS. 2 and 3, the cardan shaft 1 is designed such that the end of the first shaft section 4 of the second shaft 3, facing away from the displacement section 6, is provided with an accepting section 17, which serves to accept a connection section 19 of the exterior part 20 of the constant velocity joint 9, and with said accepting section 17 and the connection section 19 of the exterior part 20 being welded to one another (welded seam 18). Additionally, the exterior part 20 of the constant velocity joint 9 is embodied in a bell-shaped manner. At its interior side, ball bearings slides 14 are provided for balls 13, which are held in a retainer 22 and can also move in ball bearing slides 21 of the interior part of the joint.

This interior part of the joint is here embodied as an inner race 30 pinned and/or pressed onto a pin section 12 of the shaft pin 24 of the first shaft 2. For this purpose, the interior of the inner race 30 and the exterior of the pin section 12 are provided with an interlock 27. In order to axially secure the inner race 30 a safety ring is provided, into which a circular groove 26 is inserted at the axial end of the shaft pin 24 after the inner race 30 has been pinned on.

The shaft pin 24 is connected in a fixed manner by welding (welding seam 31) to the end of the first shaft 2 of the cardan shaft 1 near the synchronizing joint. A bearing section 11, in close proximity to the first shaft 2, is embodied on said shaft pin 24 for the central bearing 16 already mentioned at the outset, which is a deep groove ball bearing in the illustrated embodiment. While the interior ring of the bearing of said central bearing 16 is pressed onto the bearing section 11 the exterior ring of the bearing supports via the roller body of said bearing the above-mentioned bearing block 10, mounted at the vehicle underbody.

Another feature of one embodiment of cardan shaft 1 is a fastening section 23, arranged between the bearing section 11 for the central bearing 16 and the pin section 12 of the inner race 30, being embodied with a reduced diameter, at which a joint cap 15 is mounted with the end that has the smaller diameter. The end of said joint cap 15 with the larger diameter is fixed on the exterior of the joint exterior 20 at the fastening section 28, with a washer inserted into a circular groove 25 for sealing the grease-filled interior space of the synchronizing joint 9 being covered both radially as well as axially.

Additionally, in one embodiment cardan shaft 1 is configured for the face of the exterior side of the joint 20 and the interior side of the joint cap 15 to have a permanently elastic seal 29.

In the cardan shaft 1 according to various embodiments of the invention the two shaft sections 4, 5, not shown in greater detail here, are connected to one another via connection means, which in normal operation prevent a displacement of the axes in reference to one another, however, under the impact of an accident-related increased axial force mechanically fail as axial safety means such that the two shaft sections 4, 5 can be coaxially inserted into one another.

Cardan shaft 1, according to various embodiments of the invention, is configured such that the constant velocity joint 9 and the connection means at the two shaft sections 4, 5 are configured and adjusted to one another such that at the beginning of the impact of a predetermined first axial force F1 first the constant velocity joint 9 is telescoped along a first shift path S1 to the block and that subsequently, when a predetermined second axial force F2 impacts the cardan shaft 1, the two shaft sections 4, 5 telescope over a second shift path S2, with the first axial force F1 being weaker than the second axial force F2.

In a further development of this cardan shaft it is provided for the first axial power level F1 to amount to a value from 0 N to 1000 N, preferably from 0 N to 500 N, as well as particularly preferred from 0 N to 250 N. These values were determined from concrete results of experiments at test facilities so that these values relate to the torque-free cardan shaft. For acoustic reasons it is preferred for the axial power level to be adjusted low in the constant velocity joint.

With regard to the second axial power level F2, i.e. the one causing the two sections of the cardan shaft to telescope, a value in reference to the torque-free cardan shaft from 1000 to 20000 N is adjusted, preferably a value from 5000 to 15000 N, and particularly preferred a value from 10000 N to 12500 N.

According to another embodiment the cardan shaft is configured so that the first shift path S1, by which the constant velocity joint 9 is telescoped to the block, amounts to no more than 50 mm in each axial direction. A first shift path S1 is preferred for passenger cars amounting from 15 to 25 mm.

With regard to the second shift path S2 it is considered advantageous for it to amount to no more than 500 mm. A second shift path S2 from 200 to 250 mm is preferred for passenger cars, with the two shaft sections in the undisturbed condition to overlap in a telescoping manner by 120 mm, for example. However, this length of overlapping depends on the amount of torque transmitted by the cardan shaft.

According to another embodiment it is provided for the constant velocity joint and the connection means of the two shaft sections of the shaft to be embodied such that the cardan shaft behaves in the manner described at the outset at a bending angle from 0° to 10°, particularly from 0° to 5°, and preferably from 0° to 4°. This considers to a sufficient extent the impact-related displacement of the transmission inside the vehicle.

In one embodiment the constant velocity joint and the connection means of the two shaft sections are configured such that the constant velocity joint remains mechanically intact even after the impact of the axial force F2 and a telescoping process. This prevents the constant velocity joint from disintegration due to the impact and from its components to cause additional damage to the vehicle. An additional positive effect is the fact that such a constant velocity joint can be removed from the cardan shaft, defective by the accident, and, after a technical inspection, can be returned to use in another cardan shaft.

Although specific embodiments have been illustrated and described herein, it will be appreciated by those of ordinary skill in the art and others, that a wide variety of alternate and/or equivalent implementations may be substituted for the specific embodiment shown in the described without departing from the scope of the present invention. This application is intended to cover any adaptations or variations of the embodiment discussed herein. Therefore, it is manifested and intended that the invention be limited only by the claims and the equivalents thereof.

What is claimed is:

1. A cardan shaft (1) comprising:
a first shaft (2);
a second shaft (3) having two separate shaft sections (4, 5), each shaft section connected to one another via a connector, the connector configured to mechanically fail upon impact of a predetermined axial force and to shift the two shaft sections (4, 5) into one another coaxially in a displacement section (6); and
a constant velocity joint (9) to connect the first shaft (2) and the second shaft (3) to one another in a torque-proof manner, the constant velocity joint (9) and the connector at the two shaft sections (4, 5) configured to initially telescope the constant velocity joint (9) over a first shift path (S1) up to a block upon impact of a predetermined first axial force (F1) and subsequently upon impact of a predetermined second axial force (F2), stronger than the first axial force (F1), telescope the two shaft sections (4, 5) over a second shift path (S2).

2. A cardan shaft according to claim 1, wherein the first axial force (F1), in reference to the cardan shaft free from torque, ranges from about ON to about 1000N.

3. A cardan shaft according to claim 2, wherein the first axial force (F1), in reference to the cardan shaft free from torque, ranges from about ON to about 500N.

4. A cardan shaft according to claim 3, wherein the first axial force (F1), in reference to the cardan shaft free from torque, ranges from about ON to about 250N.

5. A cardan shaft according to claim 1, wherein the second axial force (F2), in reference to the cardan shaft free from torque, ranges from about 1000N to about 20000N.

6. A cardan shaft according to claim 5, wherein the second axial force (F2), in reference to the cardan shaft free from torque, ranges from about 5000N to about 15000N.

7. A cardan shaft according to claim 6, wherein the second axial force (F2), in reference to the cardan shaft free from torque, ranges from about 10000 N to about 12500 N.

8. A cardan shaft according to claim 1, wherein the second axial force (F2), from which the two shaft sections (4, 5) telescope, can be adjusted by the connector.

9. A cardan shaft according to claim 8, wherein the connector is a combination of welding spots between the two shaft sections (4, 5) that can tear under the impact of the axial force (F2).

10. A cardan shaft according to claim 8, wherein the connector is a combination of friction surfaces at the two shaft sections (4, 5) facing one another.

11. A cardan shaft according to claim 1, wherein the first shift path (S1) is no more than 50 mm in each axial direction.

12. A cardan shaft according to claim 1, wherein the second shift path (S2) of the two shaft sections (4, 5) is no more than 500 mm in each axial direction.

13. A cardan shaft according to claim 1, wherein the constant velocity joint (9) and the connector of the two shaft sections (4, 5) are configured to limit the power shaft to a bending angle ranging from about 0° to about 10°.

14. A cardan shaft according to claim 13, wherein the constant velocity joint (9) and the connector of the two shaft sections (4, 5) are configured to limit the power shaft to a bending angle ranging from about 0° to about 5°.

15. A cardan shaft according to claim 1, wherein the constant velocity joint (9) is configured to remain intact after the impact of the axial force (F2) and a telescoping of the two shaft sections (4, 5).

16. A method, comprising:
telescoping a constant velocity joint (9) of a cardan driveshaft (1), configured to connect a first shaft (2) and a second shaft (3), over a first shift path (S1) upon receiving an impact of a first predetermined axial force (F1); and
telescoping two shaft sections (4,5) of the second shaft (3) over a second shift path (S2) upon receiving a second predetermined axial force (F2) stronger than the first predetermined axial force (F1) to limit a bending angle of the cardan driveshaft (1).

17. A method according to claim 16, wherein the telescoping the two shaft sections (4,5) of the second shaft (3) includes mechanical failure of a connection means connecting the two sections to one another and coaxially shifting one of the two shaft sections (4,5) into a displacement region of the other one of the two shaft sections (4,5).

18. A system, comprising:
a first flexible disk (8) configured to be coupled to an output shaft of a vehicle transmission;
a second flexible disk (7) configured to be coupled to an input of a differential gear;
a first shaft (2) coupled to the second flexible disk (7);
a second shaft (3) coupled to the first flexible disk (8) and having two separate shaft sections (4, 5), each shaft section coupled to one another via a connector, the connector configured to mechanically fail upon impact of a predetermined axial force and to shift the two shaft sections (4, 5) into one another coaxially in a displacement section (6); and
a constant velocity joint (9) to couple the first shaft (2) and the second shaft (3) to one another in a torque-proof manner, the constant velocity joint (9) and the connector at the two shaft sections (4, 5) configured to initially telescope the constant velocity joint (9) over a first shift path (S1) up to a block upon impact of a predetermined first axial force (F1) and subsequently upon impact of a predetermined second axial force (F2), stronger than the first axial force (F1), telescope the two shaft sections (4, 5) over a second shift path (S2).

19. A system according to claim 18, wherein the second axial force (F2) can be adjusted by the connector in reference to the cardan driveshaft free from torque to range between at least one of about 10000 N to about 12500 N, about 5000 to about 15000 N, and/or about 1000 to about 20000 N.
